(19) United States
(12) Patent Application Publication
(10) Pub. No.: US 2004/0167680 A1
(43) Pub. Date: Aug. 26, 2004

(54) Information providing system

(75) Inventors: Toshiharu Nakajima, Fujisawa-shi (JP); Tooru Futami, Fujisawa-shi (JP)

Correspondence Address: McDERMOTT, WILL & EMERY, 600 13th Street, N.W., Washington, DC, 20005-3096, US

(73) Assignee: NISSAN MOTOR CO., LTD.

(21) Appl. No.: 10/769,858

(22) Filed: Feb. 3, 2004

(30) Foreign Application Priority Data
Feb. 13, 2003 (JP) 2003-034903

(51) Int. Cl. G06F 17/00

(52) U.S. Cl. 701/1

(57) ABSTRACT

An information providing system for vehicles according to the present invention, includes: an information providing center; and an on-vehicle apparatus. The information providing center includes: a call receiving device at which calls each corresponding to one of a plurality of numbers arrive; an information generating device that generates information to be provided corresponding to an arrival number by which a call has arrived at the call receiving device; and a transmission device that transmits the information to be provided which has been generated by the information generating device via a line on which the call has arrived. The on-vehicle apparatus includes: an operating member used to specify one of the plurality of numbers assigned thereto in advance; a call originating device that calls a number specified with the operating member; a reception device that receives the information via a line on which the call originating device has called the number; and a reproducing device that reproduces the information received by the reception device.

### BACKGROUND OF THE INVENTION

1. Field of the Invention

The present invention relates to an information providing system that provides information to a vehicle via a communication network

2. Description of the Related Art

There is an information providing system in the known art through which a mobile station such as a vehicle obtains useful information from an information center operating as an information provider by engaging in communication with the information center (see Japanese Laid Open Patent Publication No. H11-160077). In the information providing system disclosed in Japanese Laid Open Patent Publication No. H11-160077, an information acquisition apparatus installed in the vehicle obtains information provided by the information center via a portable telephone.

### SUMMARY OF THE INVENTION

A service subscriber on the vehicle side needs to request the information that he requires by directly talking to an operator at the information center or to transmit a recorded message indicating the information he requires to the information center. The service subscriber concentrating on driving his vehicle may not always be able to talk to an operator or to record a message with ease.

The present invention provides an information providing system for vehicles that allows the service subscriber to issue a request for desired information to the information center through a simple operation.

An information providing system for vehicles according to the present invention, comprises: an information providing center; and an on-vehicle apparatus. The information providing center comprises: a call receiving device at which calls each corresponding to one of a plurality of numbers arrive; an information generating device that generates information to be provided corresponding to an arrival number by which a call has arrived at the call receiving device; and a transmission device that transmits the information to be provided which has been generated by the information generating device via a line on which the call has arrived. The on-vehicle apparatus comprises: an operating member used to specify one of the plurality of numbers assigned thereto in advance; a call originating device that calls the specified number; a reception device that receives the information via a line on which the call originating device has called the number; and a reproducing device that reproduces the information received by the reception device.

An information providing center according to the present invention, comprises: a call receiving device at which calls each corresponding to one of a plurality of numbers arrive; an information generating device that generates information to be provided corresponding to an arrival number by which a call has arrived at the call receiving device; and a transmission device that transmits the information to be provided which has been generated by the information generating device via a line on which the call has arrived.

An on-vehicle apparatus according to the present invention, comprises: an operating member used to specify one of a plurality of numbers of an information providing center assigned thereto in advance; a call originating device that calls a number specified with the operating member; a reception device that receives information generated in correspondence to the specified number from the information providing center via a line on which the call originating device has called the number; and a reproducing device that reproduces the information received by the reception device.

### BRIEF DESCRIPTION OF THE DRAWINGS

FIG. 1 schematically illustrates the overall configuration of the information providing system for vehicles achieved in a first embodiment of the present invention;

FIG. 2 is an enlargement of the hands-free/audio unit;

FIG. 3 presents a flowchart of the information providing service operation executed to provide information to vehicles;

FIG. 4 presents an example of registration contents;

FIG. 5 presents an example of a registration of information details;

FIG. 6 illustrates data acquisition conditions and the information obtained in conformance to the date acquisition conditions;

FIG. 7 illustrates the hands-free/audio unit achieved in a second embodiment;

FIG. 8 presents a flowchart of the information providing service operation executed to provide information to vehicles in the second embodiment; and

FIG. 9 is a block diagram of the hands-free/audio unit.

### DESCRIPTION OF THE PREFERRED EMBODIMENTS

The following is an explanation of the embodiments of the present invention, given in reference to the drawings.

(First Embodiment)

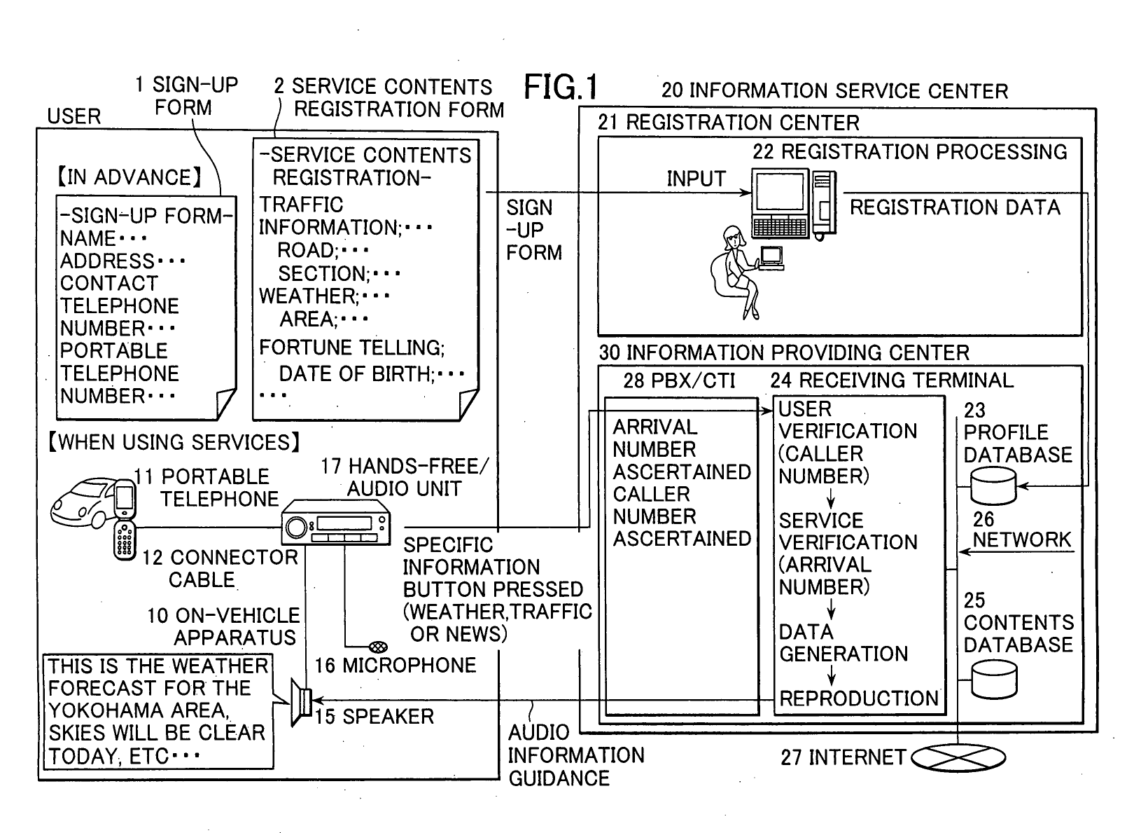

FIG. 1 schematically illustrates the overall configuration of the information providing system for vehicles achieved in the first embodiment of the present invention. The information providing system comprises an on-vehicle apparatus 10 that is installed in a vehicle such as an automobile and an information service center 20. The information service center 20 is connected to a public network (not shown) and provides information to service subscribers (users) via the public network. The on-vehicle apparatus 10 accesses the public network via a wireless telephone to enable the user to use an information providing service offered by the information service center 20 via the on-vehicle apparatus 10. The information service center 20 may also be referred to as an information providing center.

The information service center 20 comprises a registration center 21 and an information providing center 30. The registration center 21 and the information providing center 30 are connected with each other via a network. A service subscriber accesses the information providing center 30 from a mobile telephone such as a portable telephone or a cellular phone via the public network (a wireless telephone network).

The registration center 21 receives a service subscription application from a user wishing to sign up as a service subscriber in advance before the information providing center 30 starts providing information to the service subscriber. The applicant signs up to subscribe to the service by using a sign-up (application) form 1. In the sign-up form 1, the applicant enters information such as the name and the address of the applicant and the telephone number of the telephone that will be used to access the information providing center 30. It is to be noted that such information may be entered in a format the same as that of the sign-up form 1 and then may be transmitted by the applicant to the registration center 21 via the Internet from a terminal (not shown) which can be connected to the Internet. The registration center 21 registers the information related to the applicant who has signed up for the service into a database to be detailed later.

As a registered service subscriber accesses the information providing center 30, the information providing center 30 provides information requested by the service subscriber to the service subscriber via the public network (a wireless telephone network).

The present invention is characterized in that the registration center 21 and the information providing center 30 adopt structures that will allow service subscribers to obtain necessary information with ease through the information providing system for vehicles described above.

The on-vehicle apparatus 10 comprises a hands-free/audio unit 17, a portable telephone 11, a microphone 16 and a speaker 15. The hands-free/audio unit 17 and the portable telephone 11 are connected with each other through a connector cable 12. It is to be noted that the hands-free/audio unit 17 may be achieved by combining a stand-alone audio unit and a stand-alone hands-free unit.

The hands-free/audio unit 17 may be constituted as, for instance, a car audio device having a function of playing radio, CDs (compact discs) or the like, which has an additional hands-free control function used in conjunction with the portable telephone 11. When reproducing audio media such as radio or CDs, the hands-free/audio unit 17 reproduces the sound through the speaker 15.

When a hands-free telephone conversation is conducted on the portable telephone 11, the hands-free/audio unit 17 provides audio information input through the microphone 16 to the portable telephone 11. The hands-free/audio unit 17 also reproduces audio information provided through the portable telephone 11 at the speaker 15. In addition, the hands-free/audio unit 17 is structured so that a preset number to be dialed can be specified to the portable telephone 11 through a single button operation when engaging the portable telephone 11 in a calling operation. The term “single button operation” in this context refers to a quick operation that can be performed through a single action or two actions.

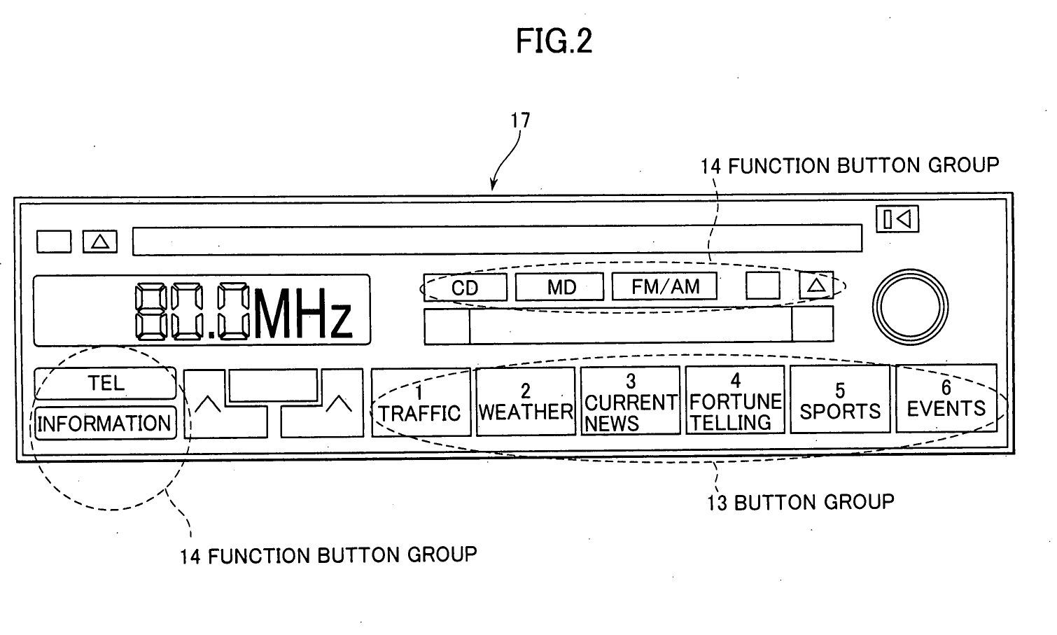

FIG. 2 is an enlargement of the hands-free/audio unit 17. The hands-free/audio unit 17 includes a group of buttons 13 and a group of function buttons 14 in FIG. 2. The function button group 14 is constituted of buttons each operated to select a specific function of the hands-free/audio unit 17. The function button group 14 includes, for instance, a “CD” function button, a “MD” function button, an “FM/AM” function button, a “TEL” function button and an “INFORMATION” function button. The “CD” function button is operated to play a CD, whereas the “MD” function button is operated to play an MD (mini disc). The “FM/AM” function button is a reception band switching button operated to receive broadcast radio. The “TEL” function button is operated to enable a hands-free telephone conversation. The “INFORMATION” function button is operated to obtain information from the information providing center 30.

The button group 13 may include, for instance, six buttons “1”, “2” . . . “5” and “6”. When reproducing a CD or an MD, functions such as “fast forward” and “rewind” are assigned to the buttons constituting the button group 13. In addition, they fulfill a station selection function for selecting a radio station while the radio is on. Each button is preset to select a specific station frequency. They also fulfill a selection function for selecting a specific number to dial for a hands-free telephone conversation. Each button is preset or pre-assigned with a specific dialing number. The buttons are also assigned with a selection function for selecting a number to call to obtain a specific type of information. Each button is pre-assigned with a specific dialing number to fulfill this function as well. The buttons are pre-assigned to enable these selections at the factory or the like prior to shipment of the hands-free/audio unit 17. Alternatively, the buttons may be set for such pre-assignment by the user after the hands-free/audio unit 17 is shipped from the factory. In such a case, pre-assignment is achieved by using the function button group 14, the button group 13 and the like.

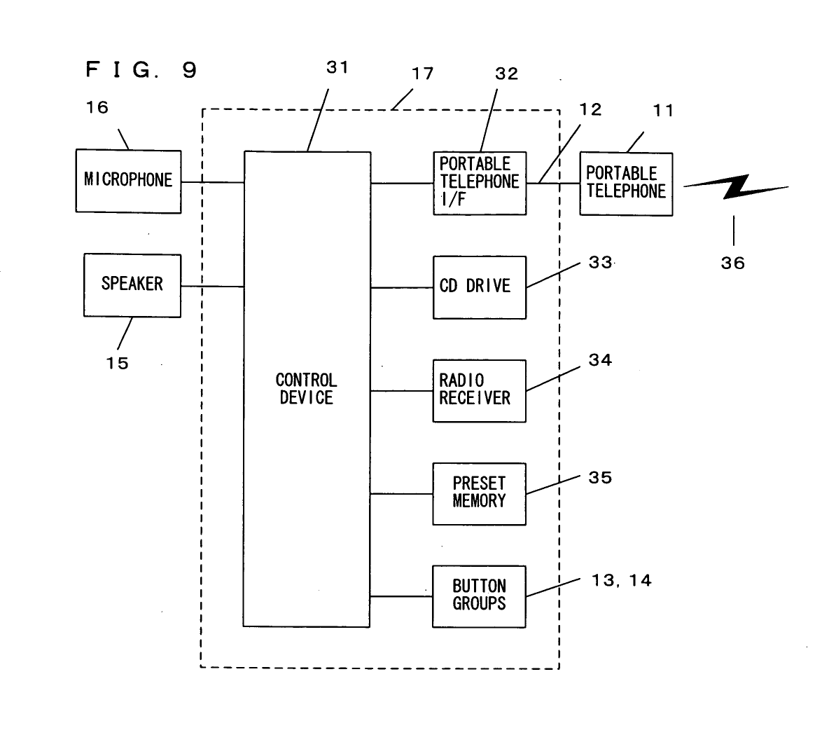

FIG. 9 is a block diagram of the hands-free/audio unit 17. The hands-free/audio unit 17 comprises a control device 31, a portable telephone interface 32, a CD drive 33, an MD drive (not shown), a radio receiver 34, a preset memory 35, the button groups 13 and 14 and the like.

The control device 31 constituted with a microprocessor and its peripheral circuits implements overall control of the hands-free/audio unit 17. A specific program, which is stored in a ROM (not shown), is executed. The portable telephone interface 32 having an interface function for achieving interface with the portable telephone 11 enables exchange of various types of information with the information center 30 via the portable telephone 11 and a public line 36. The control device 31 and the portable telephone interface together function as an information transmission/reception device in the on-vehicle apparatus 10. It is to be noted that they may be regarded to function as a transmission/reception device together with the portable telephone 11, as well. The CD drive 33 plays a music CD or the like and outputs the music or the like through the speaker 15 via the control device 31. The radio receiver 34 receives broadcast radio and outputs the radio broadcast via the control device 31.

The preset memory 35 is a memory used to store the dialing numbers, the broadcasting station frequencies and the like each preset in correspondence to one of the buttons in the button group 13. Telephone numbers to be dialed for hands-free conversation and telephone numbers to be dialed to obtain information can be set in the preset memory 35. The control device 31 controls the hands-free function as well. It also controls the pre-assignment executed by the user after the factory shipment by using the function button group 14, the button group 13 and the like.

The registration center 21 shown in FIG. 1 includes a registration processing terminal 22. The registration processing terminal 22 is connected to the information providing center 30 via a network. The registration center 21 and the information providing center 30 do not need to be located within a single facility. The registration processing terminal 22 is operated by an operator to register the information related to the applicant signing up for the service. It is to be noted that if the applicant is signing up via the Internet, the registration processing terminal 22 automatically registers the information transmitted from the applicant terminal. The registered data are then provided to the information providing center 30 via the network.

In the first embodiment, the service subscriber pre-registers categories of information he wishes to obtain from the information service center 20 by submitting a service contents registration form 2 or the like. The information categories refer to various types of information such as traffic information, weather information and fortune telling information. The service subscriber wishing to obtain the traffic information registers a specific road, a road segment or the like. If he wishes to obtain weather information, he registers a specific area or the like as well. The service subscriber wishing to obtain fortune telling information also registers his date of birth and the like. At the registration center 21, the types of information requested by each service subscriber are registered in a database in correspondence to the information related to the service subscriber. Namely, the service subscriber registers in advance the types of services he wishes to use and detailed information on the services he wishes to use at the registration center 21. It is to be noted that such information entered in the same format as that of the service contents registration form 2 may be transmitted by the service subscriber to the registration center 21 via the Internet from a terminal (not shown) that can be connected to the Internet, instead.

The information providing center 30 comprises a PBX/CTI 28, a receiving terminal 24, a profile database 23 and a contents database 25. The receiving terminal 24, the profile database 23 and the contents database 25 are individually connected with a network 26. The network 26 is also connected to the Internet 27.

The PBX/CTI 28 connects a call coming in through a public network to the receiving terminal 24. The receiving terminal 24 exchanges data with the on-vehicle apparatus 10 of the service subscriber via the public network (a wireless telephone network) and also executes data processing on the information to be provided to the service subscriber to prepare it as transmission data. The profile database 23 stores (records) therein the information of the service subscriber transmitted from the registration center 21 via the network. The information stored therein is read out in response to a request issued by the receiving terminal 24.

The contents database 25 stores therein information in various categories to be provided to service subscribers, i. e., it stores therein a plurality of types of information separately. The information in the contents database 25 is updated with the latest information via the Internet 27. It is to be noted that the manager of the information providing center 30 is responsible for maintenance of the contents database 25.

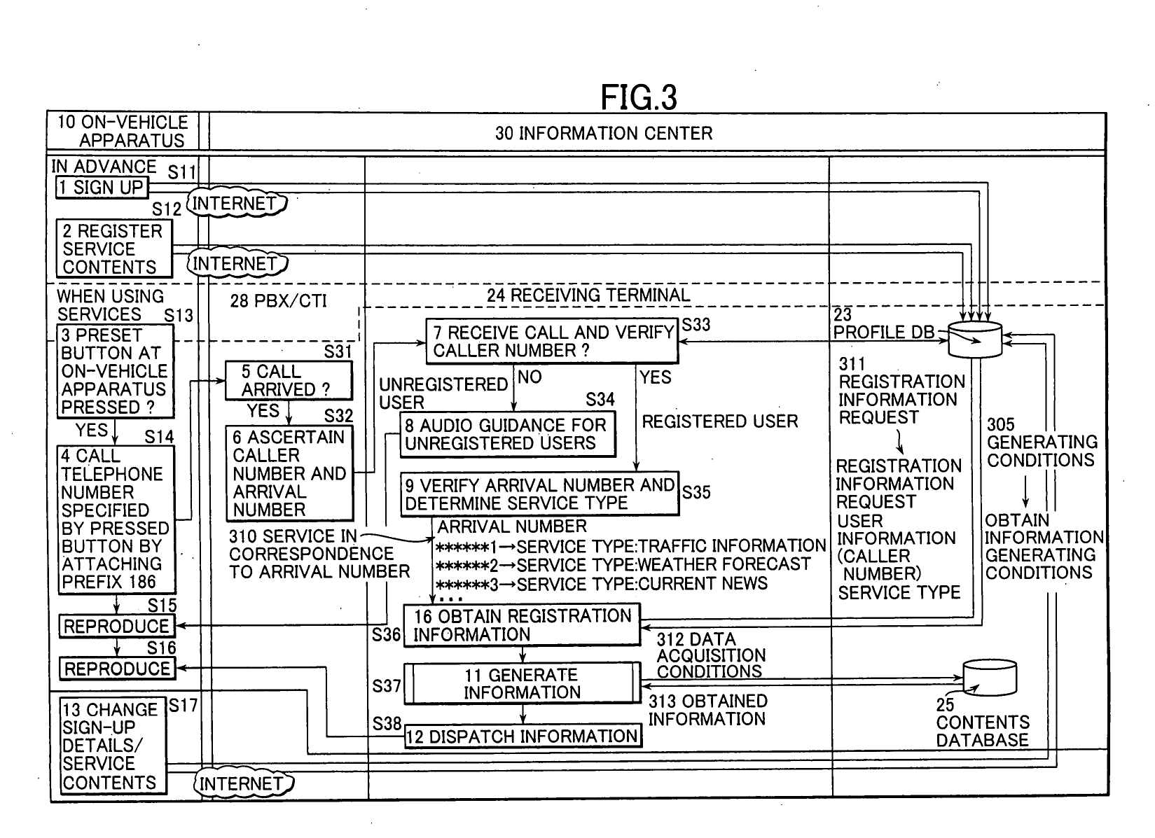

The flow of the vehicle information providing service operation executed in the information providing system for vehicles described above is now explained in reference to the flowchart presented in FIG. 3. The processing at the on-vehicle apparatus 10 is executed by the hands-free/audio unit 17. It is to be noted that a customer signs up as a service subscriber and registers the contents of desired services through a terminal (not shown) that can be connected to the Internet. This terminal does not need to be installed in the service subscriber's vehicle. The processing at the information providing center 30 is executed by the PBX/CTI 28 and the receiving terminal 24.

In step S11 in FIG. 3, the terminal (not shown) of the service subscriber transmits the sign-up information described earlier to the information providing center 30 in response to a sign up operation performed by the service subscriber and then the operation proceeds to step S12. The sign-up information transmitted to the information providing center 30 is stored into the profile database 23. In step S12, the terminal (not shown) of the service subscriber transmits the registration information described earlier to the information providing center 30 in response to a registration operation for registering the service contents performed by the service subscriber, and then the operation proceeds to step S13. The registration information transmitted to the information providing center 30 is stored into the profile database 23 in correspondence to the sign-up information.

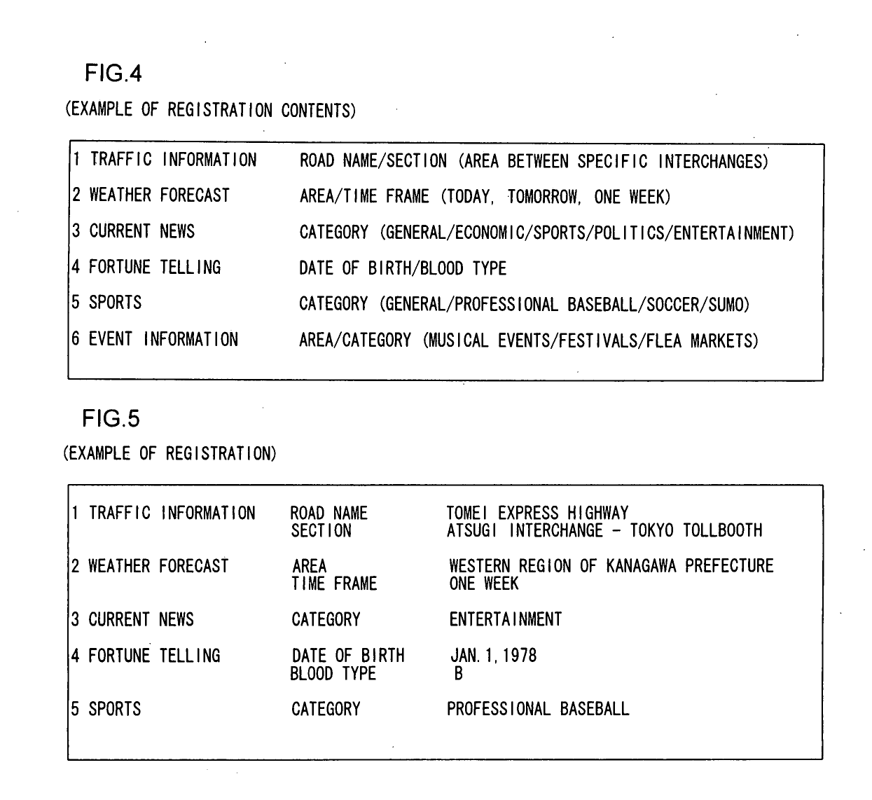

FIG. 4 presents an example of registration contents. Six menus are available as information categories in FIG. 4, that include; 1. traffic information, 2. weather information, 3. news, 4. fortune telling, 5. sports and 6. event information.

Information details are set in correspondence to each information category. The information details corresponding to the traffic information may be a road name and a road section (an area between specific interchanges). The information details corresponding to the weather forecast maybe, for instance, an area and a time frame (today and tomorrow, 1 week). The information details corresponding to the current news include different news categories (general, economic, sport, politics, entertainment, etc.). The information details corresponding to the fortune telling information may be the date of birth and the blood type. The information details corresponding to sports include various sport categories (general, professional baseball, soccer, sumo wrestling, etc.). The information details corresponding to the event information may be a specific area and a specific category (musical event, festival, flea market, etc.).

FIG. 5 presents an example of an information detail registration. In FIG. 5, “Tomei Express Highway” and “Atsugi interchange to Tokyo Tollbooth” are respectively registered in the road name field and the section field of 1. traffic information. Each service subscriber registers desired specifics for the corresponding information details in each information category, as shown in the figure. As a result, the desired specifics of the information details in the information categories requested by each service subscriber are registered in correspondence to the telephone number of the service subscriber having signed up for the service.

The processing in step S13 and subsequent steps in FIG. 3 is executed at the on-vehicle apparatus 10 when the service subscriber uses the service. In step S13, a decision is made by the hands-free/audio unit 17 as to whether or not any preset buttons have been pressed down. The hands-free/audio unit 17 makes an affirmative decision in step S13 if operation signals have been input from the function button group 14 and the button group 13 to proceed to step S14, whereas it makes a negative decision in step S13 if no operation signals have been input from the function button group 14 and the button group 13 to repeatedly execute the decision-making processing.

If an operation signal from one of the buttons in the button group 13 is input following an operation signal from the “INFORMATION” function button in the function button group 14, the hands-free/audio unit 17 reads out data indicating the telephone number preset at the hands-free/audio unit 17 in correspondence to the button (one of the buttons in the button group 13) and issues a command for the portable telephone 11 to dial the telephone number in step S14. In response, the portable telephone 11 engages in an operation to call the information providing center 30. In the first embodiment, the six buttons “1”, “2” . . . “5” and “6” in the button group 13 are respectively pre-assigned with telephone numbers at the information providing center 30 to be dialed to obtain 1. traffic information, 2. weather information, 3. current news, 4. fortune telling information, 5. sports and 6. event information.

The hands-free/audio unit 17 instructs the portable telephone 11 to dial the specific telephone number of the information providing center 30 by attaching a prefix number (e.g., 186) to indicate or inform the caller telephone number of the portable telephone 11 to the information providing center 30. A plurality of lines are installed at the information providing center 30 and different telephone numbers are assigned in correspondence to the individual information categories, i.e., 1. traffic information, 2. weather information, 3. current news, 4. fortune telling information, 5. sports and 6. event information. A call made by dialing any of these numbers is connected to the information providing center 30. Once the calling operation is executed, the hands-free/audio unit 17 proceeds to step S15.

If, on the other hand, an operation signal has been input from one of the function buttons “CD”, “MD”, “FM/AM” and “TEL” in the function button group 14, the hands-free/audio unit 17 executes an operation corresponding to the function button from which the operation signal has been input. For instance, if an operation signal has been input from the “CD” function button, the hands-free/audio unit 17 plays a CD. It is to be noted that since the present invention is characterized by the operation executed when the “INFORMATION” function button in the function button group 14 has been operated, a detailed explanation of operations executed in correspondence to the function buttons other than the “INFORMATION” function button is omitted.

In step S31, the PBX/CTI 28 at the information providing center 30 makes a decision on as to whether or not an incoming call has arrived. The PBX/CTI 28 makes an affirmative decision in step S31 if an incoming call has arrived to proceed to step S32, whereas it makes a negative decision in step S31 if there has been no incoming call to repeatedly execute the decision-making processing described above. The PBX/CTI 28 constitutes a call receiving device at which a call arrives.

In step S32, the PBX/CTI 28 obtains and ascertains an arrival number. The arrival number is a dialing number. Arrival numbers arriving at the PBX/CTI 28 vary according to the individual dialing numbers, i.e., to the individual information categories. The PBX/CTI 28 also obtains the telephone number of the portable telephone 11 of the caller (call originator), transmits information indicating the arrival number and the caller telephone number to the receiving terminal 24 and directs the call to the receiving terminal 24 before the operation proceeds to step S33.

In step S33, the receiving terminal 24 executes a user authentication or verification. More specifically, it makes a decision as to whether or not the caller telephone number having been ascertained is registered in the profile database 23. The user authentication is executed with regard to the caller, i.e., the service user, identified based upon the caller telephone number. The caller telephone number is used as identifier information used to identify the caller. The user authentication is executed when offering members-only services through the information providing system. The telephone number of the portable telephone 11 of each registered member (service subscriber) is registered at the profile database 23 when the member signs up for the service as described above. If the caller telephone number is registered in the profile database 23, the receiving terminal 24 recognizes the incoming call as a call from a member.

The receiving terminal 24 makes an affirmative decision in step S33 if the caller telephone number is registered in the profile database 23 to proceed to step S35. If, on the other hand, the caller telephone number is not registered in the profile database 23, the receiving terminal 24 makes a negative decision in step S33 to proceed to step S34. In step S34, the receiving terminal 24 provides audio guidance for unregistered users as described below. The receiving terminal 24 transmits the guidance information such as a message “Member registration is required to use this service” to the on-vehicle apparatus 10 and then disconnects the line between the on-vehicle apparatus 10 and the information providing center 30 before the operation returns to step S31. The hands-free/audio unit 17 at the on-vehicle apparatus 10 then reproduces the guidance information through the speaker 15 in step S15. If no guidance information is transmitted from the information providing center 30, the hands-free/audio unit 17 skips step S15.

In step S35, the receiving terminal 24 authenticates or verifies the arrival number and determines the type of service requested by the service subscriber (the requested information category in this example), before the operation proceeds to step S36. The type of the requested service is a service 310 provided in correspondence to the arrival number in FIG. 3. For instance, if the arrival number is *****1, 1. traffic information is selected as the service type. If the arrival number is *****2, 2. weather information is selected as the service type. If the arrival number is *****3, 3. current news is selected as the service type. Likewise, if the arrival number is *****6, 6. event information is selected as the service type.

In step S36, the receiving terminal 24 accesses the profile database 23 and issues a registration information request 311 by using the caller telephone number and the determined service type as a search key. The registration information request 311 is issued to request the information details of the service contents registered in step S12 in correspondence to the specific service type (the specific information category). These information details are referred to as information generating conditions 305. After the receiving terminal 24 obtains the information generating conditions 305 corresponding to the registration information request 311 from the profile database 23, the operation proceeds to step S37.

In step S37, the receiving terminal 24 executes information generation processing. In more specific terms, the receiving terminal 24 generates data acquisition conditions 315 based upon the information generating conditions 305, accesses the contents database 25 and obtains information 313 matching the data acquisition conditions 312 from the contents database 25.

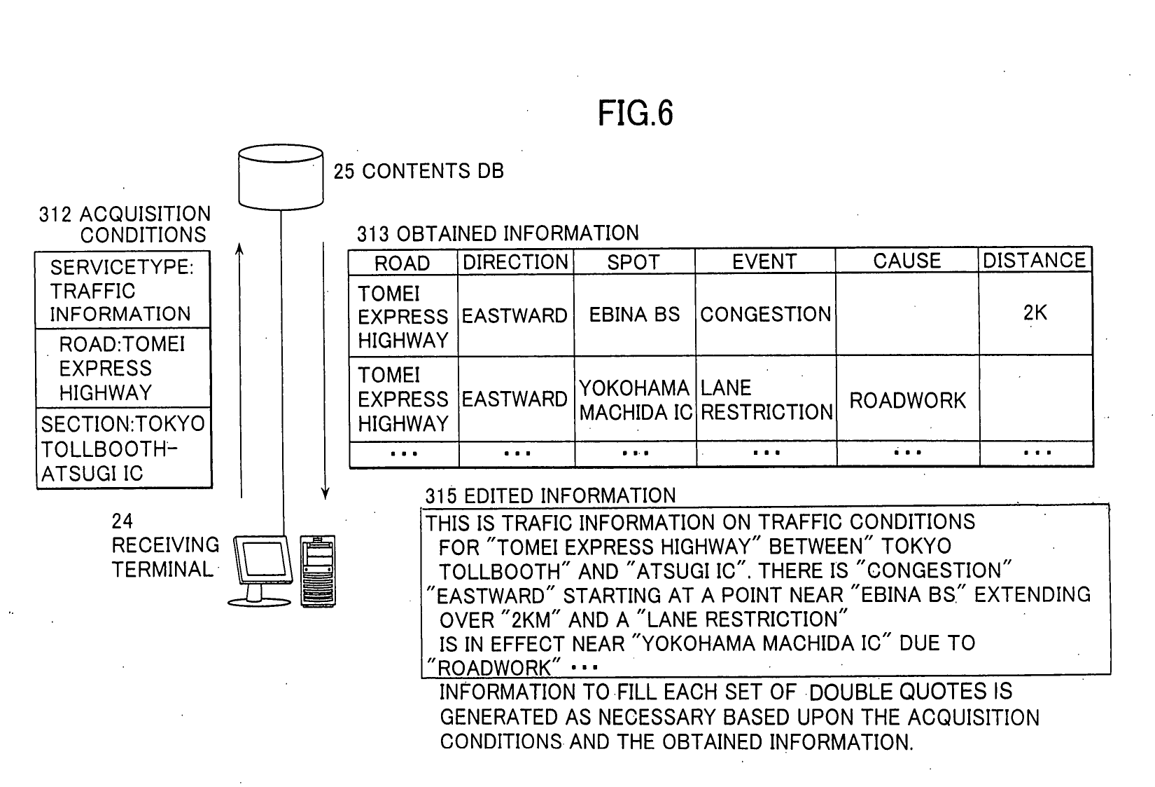

FIG. 6 illustrates the data acquisition conditions 312 and the information 313 obtained in correspondence to the data acquisition conditions 312. The data acquisition conditions 312 may include, for instance, “service type; traffic information”, “road; Tomei Express Highway” and “section; Tokyo Tollbooth to Atsugi IC”. The information 313 obtained in correspondence to the data acquisition conditions 312 may include, for instance, “Tomei Express Highway (road), eastward (direction), Ebina BS (point), congestion (event), 2 km (distance)” and “Tomei Express Highway (road) and eastward (direction), Yokohama Machida IC (point), lane restriction (event)”. The direction of the obtained information 312 maybe replaced with bound-for information. For example, the above “eastward (direction)” maybe replaced with “Tokyo (bound for)”.

Upon obtaining the information 313 from the contents database 25, the receiving terminal 24 proceeds to step S38. In step S38, the receiving terminal 24 edits the obtained information 313 to prepare guidance information. Namely, the receiving terminal 24 inserts the contents of the obtained information 313 in a predetermined form and prepares edited information 315 by editing the obtained information 313 as a message: (This is traffic information on traffic conditions for the “Tomei Express Highway” between “Tokyo Tollbooth” and “Atsugi IC”. There is “congestion” “eastward” starting at a point near “Ebina BS” and extending over “2 km” and a “lane restriction” is in effect “eastward” due to “roadwork” near “Yokohama Machida IC”.)

It is to be noted that the contents in each set of double quotes in the edited information 315 are generated as necessary based upon the acquisition conditions 312 and the obtained information 313 to be inserted in the form. The descriptions other than contents in double quotes are predetermined in the form. The receiving terminal 24 also transmits audio guidance communicating the edited information 315 to the portable telephone 11 of the on-vehicle apparatus 10 via the PBX/CTI 28 and the public network (wireless telephone network). Namely, the receiving terminal 24 which is capable of generating a plurality of types of information, generates a specific type of information matching particular data acquisition conditions 312. The receiving terminal 24 functions as an information generating device. In addition, the receiving terminal 24 and the PBX/CTI 28 together function as a transmission device that transmits the edited information 315 to the on-vehicle apparatus 10. After the audio guidance is dispatched, the PBX/CTI 28 disconnects the line between the on-vehicle apparatus 10 and the information providing center 30′.

In step S16, the hands-free/audio unit 17 at the on-vehicle apparatus 10 reproduces the audio guidance through the speaker 15 to provide the service subscriber with the edited information 315. Once the reproducing operation is completed, the hands-free/audio unit 17 returns to step S13. The control device 31 and the speaker 15 at the on-vehicle apparatus 10 function as an information reproducing device. It is to be noted that a small display screen may be provided at the hands-free/audio unit 17 so as to reproduce the information on display at the screen, as well.

The service contents registered in step S12 as described above may be changed before the service subscriber uses the services next time. As the service subscriber performs a service contents registration changing operation, the new registration information is transmitted to the information providing center 30 from the service subscriber's terminal (not shown) in step S17, and then the operation returns to step S13. The new registration information transmitted to the information providing center 30 is registered (used for an update) in place of the old registration information in the profile database 23 by the registration processing terminal 22.

The following advantages are achieved in the first embodiment described above.

(1) A plurality of lines are installed at the information providing center 30 in correspondence to the individual information categories to be specified by the service subscriber (1. traffic information, 2. weather information, 3. current news, 4. fortune telling information, 5. sports and 6. event information in the example described above) and different telephone numbers are assigned to these lines. By selecting the telephone number corresponding to a specific information category, the service subscriber is able to select the category of the information he wishes to obtain. In addition, the individual telephone numbers are each pre-assigned to one of the buttons constituting the button group 13 at the hands-free/audio unit 17, and thus, the service subscriber can specify a telephone number to dial by pressing down one of the preset buttons. As a result, the desired type of information can be selected with a high degree of reliability through a simple operation.

(2) The information details corresponding to the individual information categories (a specific road name and a specific section of the road in the case of the traffic information) are pre-registered in the profile database 23 at the information providing center 30. At the information providing center 30, information 313 to be obtained which matches the information details pre-registered by the service subscriber is obtained from the contents database 25 (step S37), contents of the obtained information 313 are inserted in the predetermined form and thus, edited information 315 to be provided as the audio guidance is prepared (step S38). As a result, a safe information providing system that does not require the service subscriber requesting information to specify the information details with regard to the desired information category and does not distract the service subscriber from driving operations can be provided. In addition, since the data in the contents database 25 are edited to prepare information satisfying the request from the service subscriber, the versatility of the contents database 25 is improved, and the running costs can be kept lower than those of a system having a plurality of contents databases 25 in correspondence to different types of information requested by service subscribers. Furthermore, since the information provided to the service subscriber is reproduced as an audio message, the information is provided by assuring the safety of the service subscriber driving the vehicle.

(3) Since no operators need to man the information providing center 30, the running costs can be reduced. In addition, since the service subscriber does not need to talk to an operator, he is not distracted from driving the vehicle. As a result, a safe information providing system is achieved.

The PBX/CTI 28 that controls the line on which an incoming call arrives may be omitted. In such a case, the arrival number and the telephone number of the portable telephone 11 from which a call originates should be obtained and ascertained by the receiving terminal 24.

A plurality of receiving terminals 24 may be provided each in correspondence to one of the plurality of lines installed at the information providing center 30.

Instead of installing a plurality of lines at the information providing center 30, a single line may be used for a plurality of service types (e.g., traffic information and weather forecasts) through so-called centrex services and dial-in services.

The service contents may be registered only for the categories of information desired by a given service subscriber. In such a case, the service subscriber selects only desired categories from the six menus, i.e., 1. traffic information, 2. weather information, 3. current news, 4. fortune telling information, 5. sports and 6. event information, for registration.

In step S35, the receiving terminal 24 obtains the generating conditions 305 corresponding to the registration information request 311 from the profile database 23. Instead, if the user is authenticated as a registered subscriber in step S33, the information generating conditions 305 may be obtained from the profile database 23 at this time point.

The edited information 315 may be prepared by editing text data or by editing pre-recorded audio information. When preparing the edited information 315 by editing text data, the data should be converted to audio information with a text-to-speech conversion (text read-aloud) program provided for audio reproduction. If the edited information 315 is prepared by editing audio information, the edited audio information can be directly reproduced.

The telephone number of the portable telephone 11 of each service subscriber is registered in the profile database 23 in the information providing system. Instead, member IDs may be registered. In this case, after a call is made from a portable telephone 11 to establish a line connection with the information providing center 30, the corresponding ID is transmitted from the on-vehicle apparatus 1 to the information providing center 30. If the ID is registered in a user ID database (profile database 23), the receiving terminal 24 can verify that the incoming call has been placed by a member. The ID-based user authentication eliminates the need to attach the prefix number to inform the caller telephone number, i. e., the telephone number of the portable telephone 11, to the telephone number dialed to the information providing center 30.

(Second Embodiment)

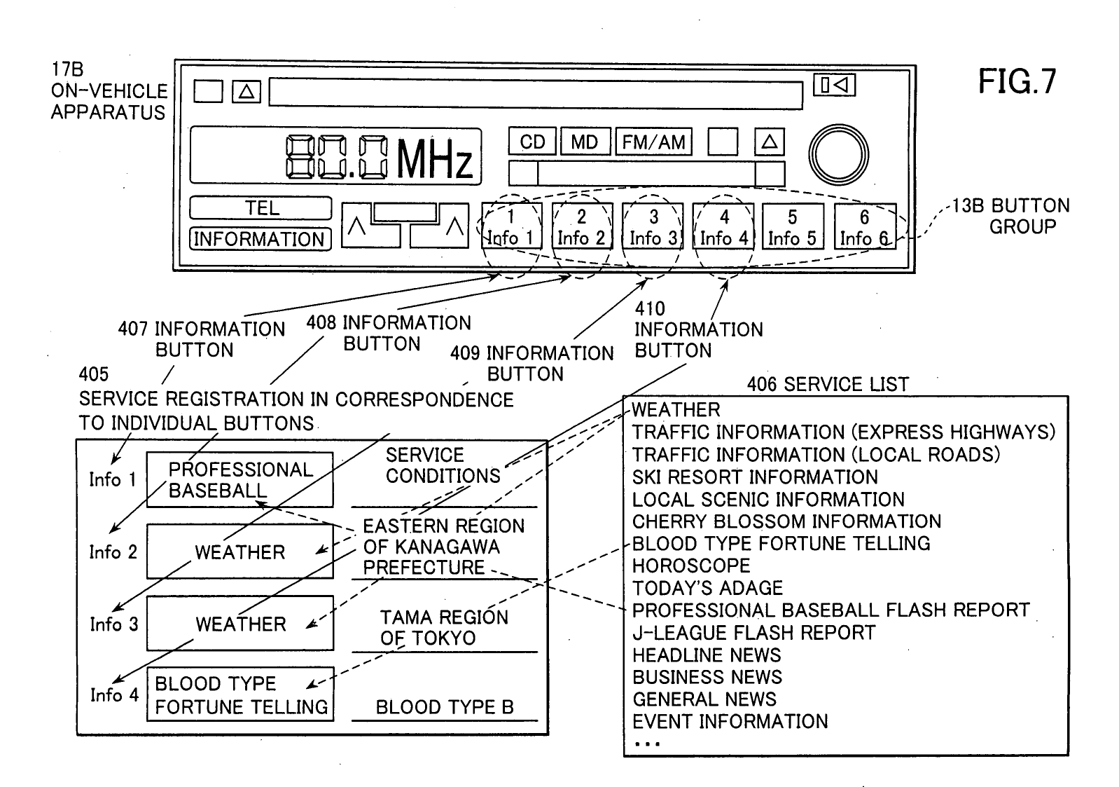

FIG. 7 illustrates a hands-free/audio unit 17B achieved in the second embodiment of the present invention. Unlike in the first embodiment, telephone numbers of the information providing center that provides information are not pre-assigned to the buttons “407”, “408”, . . . “411” and “412” in a group of buttons 13B in the second embodiment. In the second embodiment, each service subscriber is allowed to pre-assign dialing numbers (dialing numbers at the information providing center) to the buttons as personal settings.

The service subscriber selects the categories (service types) of information he wishes to obtain from a service list 406 at the time of service registration. In the example presented in FIG. 7, real-time professional baseball news is registered at the button 407 (info1), weather information for the eastern region of Kanagawa Prefecture is registered at the button 408 (info2), weather information for the Tama region of Tokyo is registered at the button 409 (info3) and blood type fortune telling information is registered at the button 410 (info4). The service subscriber registers these information categories by using a service contents registration form or via the Internet, as in the first embodiment.

The service subscriber pre-assigns the dialing numbers corresponding to the registered service types at the individual buttons of the button group 13B.

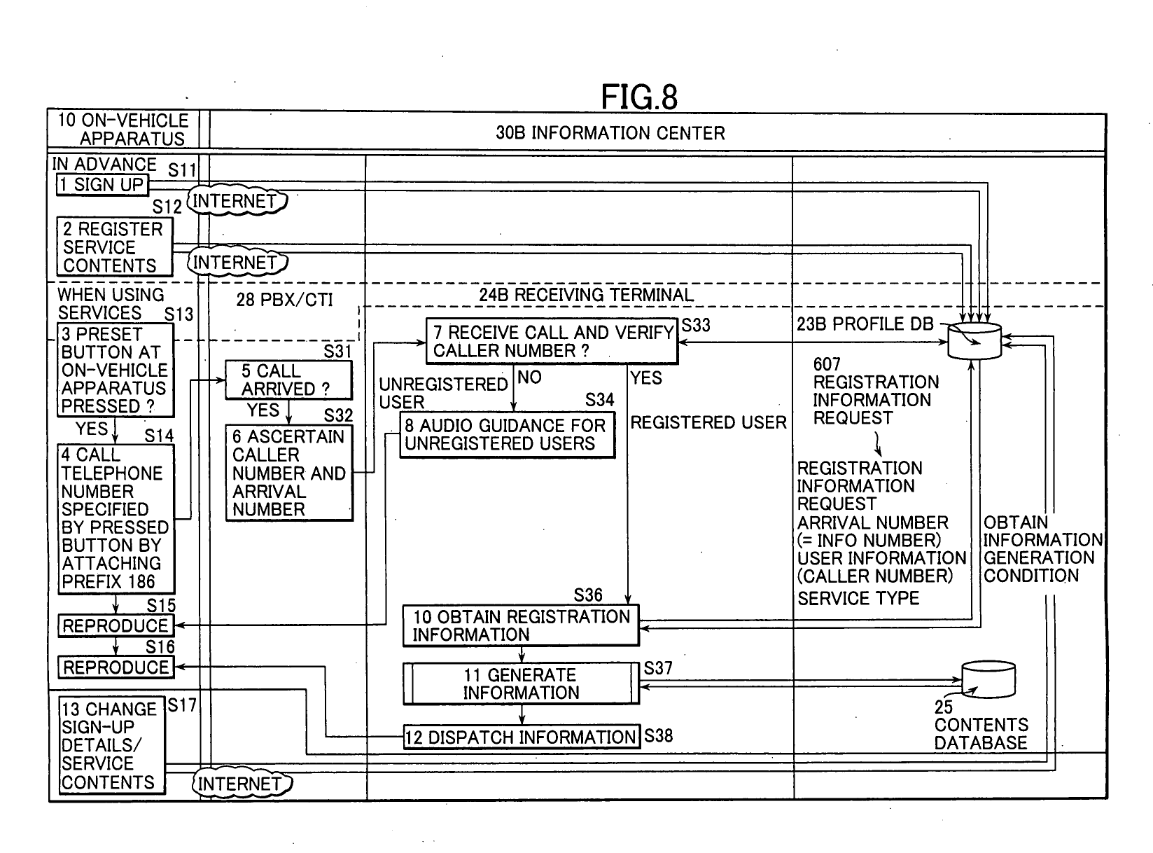

FIG. 8 presents a flowchart of the information providing service operation executed to provide information to vehicles in the information providing system for vehicles in the second embodiment. In the flowchart presented in FIG. 8, the processing at the information providing center 30B is executed by the PBX/CTI 28 and a receiving terminal 24B. The processing differs from that executed in the first embodiment in that the processing in step S35 is omitted and that a profile database 23B is used instead of the profile database 23. Accordingly the following explanation focuses on these differences.

In step S33 in FIG. 8, the receiving terminal 24B executes the user authentication described earlier. The receiving terminal 24B makes an affirmative decision in step S33 if the caller telephone number is registered in the profile database 23B to proceed to step S36. If, on the other hand, the caller telephone number is not registered in the profile database 23B, the receiving terminal 24B makes a negative decision in step S33 to proceed to step S34.

In step S36, the receiving terminal 24B accesses the profile database 23B and issues a registration information request 607 by using the caller telephone number and the arrival number as the search key. The arrival number used at this time corresponds to the “info” number assigned to the specific button in the button group 13B. The registration information request 607 is issued to request the information details corresponding to the service contents registered with regard to the specific service type (information category). These information details are referred to as information generating conditions. Once the information generating condition corresponding to the registration information request 607 are received at the terminal 24B from the profile database 23B, the operation proceeds to step S37.

The second embodiment explained above also allows the service subscriber to select the type of information he wishes to obtain through a simple operation as does the first embodiment. In addition, even when the number of service types (information categories) is greater than the number of preset buttons at the hands-free/audio unit 17, the service subscriber can pre-assign specific service types to the buttons as personal settings, and thus the service subscriber is able to select the categories of information that match his personal needs which affords great convenience to the service subscriber.

The first embodiment and the second embodiment described above may be adopted in combination. In such a case, three of the buttons constituting the button group at the hands-free/audio unit 17 may be pre-assigned with specific dialing numbers at the information providing center with the remaining three buttons left available to be assigned as personal settings selected by the service subscriber.

The above described embodiments are examples and various modifications can be made without departing from the spirit and scope of the invention.

The disclosure of the following priority application is herein incorporated by reference. Japanese Patent Application No. 2003-034903 filed Feb. 13, 2003

What is claimed is:

1. An information providing system for vehicles, comprising:
an information providing center; and
an on-vehicle apparatus, wherein
the information providing center comprises:
a call receiving device at which calls each corresponding to one of a plurality of numbers arrive;
an information generating device that generates information to be provided corresponding to an arrival number by which a call has arrived at the call receiving device; and
a transmission device that transmits the information to be provided which has been generated by the information generating device via a line on which the call has arrived, and wherein
the on-vehicle apparatus comprises:
an operating member used to specify one of the plurality of numbers assigned thereto in advance;
a call originating device that calls the specified number;
a reception device that receives the information via a line on which the call originating device has called the number; and
a reproducing device that reproduces the information received by the reception device.

2. An information providing system for vehicles according to claim 1, wherein:
the call originating device transmits identifier information used to identify a call originator;
the information providing center further includes an identifying device that identifies the call originator based upon the identifier information received via the line, and a recording device that records information-generating information in advance in correspondence to the call originator; and
the information generating device generates the information to be provided corresponding to the arrival number by referencing the information-generating information recorded at the recording device in correspondence to the call originator identified by the identifying device.

3. An information providing center, comprising:
a call receiving device at which calls each corresponding to one of a plurality of numbers arrive;
an information generating device that generates information to be provided corresponding to an arrival number by which a call has arrived at the call receiving device; and
a transmission device that transmits the information to be provided which has been generated by the information generating device via a line on which the call has arrived.

4. An information providing center according to claim 3, further comprising:
an identifying device that identifies the call originator based upon identifier information received via the line; and
a recording device that records information-generating information in advance in correspondence to the call originator, wherein:
the information generating device generates the information to be provided corresponding to the arrival number by referencing the information-generating information recorded at the recording device in correspondence to the call originator identified by the identifying device.

5. An information providing center according to claim 3, wherein:
the information generating device generates a plurality of types of information to be provided each in correspondence to one of the plurality of numbers.

6. An information providing center according to claim 5, wherein:
the plurality of types of information to be provided include at least one of traffic information, weather forecast information, current news information, fortune telling information, sports information and event information.

7. An information providing center according to claim 4, wherein:
the identifying device executes an authentication of the identified call originator.

8. An information providing center according to claim 4, wherein:
the information to be provided is reproduced as an audio message.

9. An on-vehicle apparatus, comprising:
an operating member used to specify one of a plurality of numbers of an information providing center assigned thereto in advance;
a call originating device that calls a number specified with the operating member;
a reception device that receives information generated in correspondence to the specified number from the information providing center via a line on which the call originating device has called the number; and
a reproducing device that reproduces the information received by the reception device.

10. An on-vehicle apparatus according to claim 9, wherein:
the operating member is an operating member used to enable hands-free telephone conversation.

11. An on-vehicle apparatus according to claim 9, wherein:
the reproducing device reproduces the information as an audio message.

12. An on-vehicle apparatus according to claim 9, further comprising:
a radio receiver that receives broadcast radio.

13. An on-vehicle apparatus according to claim 12, wherein:
the operating member also functions as a station selecting member used to select a radio station.

14. An on-vehicle apparatus according to claim 9, further comprising:
a hands-free control device that controls a hands-free operation of a portable telephone.

15. An on-vehicle apparatus according to claim 14, wherein:
the operating member also functions as a specifying member used to specify a number to be dialed on the portable telephone operating under hands-free control.

16. An information providing system for vehicles, comprising;
an information providing center; and
an on-vehicle apparatus, wherein
the information providing center comprises:
means for receiving calls each corresponding to one of a plurality of numbers;
means for generating information to be provided corresponding to an arrival number by which a call has arrived at the means for receiving calls; and
means for transmitting the information to be provided which has been generated by the means for generating information to be provided via a line on which the call has arrived, and wherein
the on-vehicle apparatus comprises:
an operating member used to specify one of the plurality of numbers assigned thereto in advance;
means for calling the number specified with the operating member;
means for receiving the information via a line on which the means for calling has called the number; and
means for reproducing the information received by the receiving means.
